(19) United States
(12) Patent Application Publication
(10) Pub. No.: US 2012/0126085 A1
(43) Pub. Date: May 24, 2012

(54) Versatile Lift For Chair, Recliner Or Objects

(76) Inventor: Edmund Harry Johnson, Cameron Park, CA (US)

(21) Appl. No.: 13/082,284

(22) Filed: Apr. 7, 2011

Related U.S. Application Data
(60) Provisional application No. 61/458,221, filed on Nov. 19, 2010.

(51) Int. Cl. F16M 13/00

(52) U.S. Cl. 248/346.03

(57) ABSTRACT

A lifting fixture accommodates loads with wide variations of undercarriage types and uneven floors or platforms, and provides a minimum manufacturing cost. The lift especially accommodates loads such as chairs and recliners designed for comfort or for infirm individuals and lifts those loads by an amount that enables safe, convenient access.

The present application claims the benefit of and priority to U.S. Provisional Patent Application No. 61/458,221 titled “VERSATILE LIFT FOR CHAIR, RECLINER OR OBJECTS” and filed on Nov. 19, 2010.

### FIELD

The field of the invention relates generally to a cradle or lift fixture to render existing apparatus such as chairs and bulky shop equipment more accessible, and more particularly relates to a method and system for a cradle or lifting fixture for a user-supplied chair or recliner that enables individuals having various physical sizes, physical challenges and different ages to more conveniently lift themselves off the chair or recliner.

### BACKGROUND

There is a need for a non-electrical, non-hydraulic lifting fixture for fitting user-supplied loads, such as commercially available chairs and recliners which are supported by feet or runners or other variations of undercarriages. Undercarriages may deform with use. Cost is also a key element.

Lifting fixtures that accommodate some variations of undercarriages of commercially available apparatus, chairs or recliners are found in the literature. A design found in the art typical of its type accommodates only rocker-recliners with parallel runners (long flat wooden feet). The design is considered weak in that a heavy person flopping down on the recliner could cause its wooden wedge shaped lifts or cam elements to shear.

Another design typical of its type only supports objects such as chairs that have four individual perpendicular legs. These designs fail to support rocker-recliners or objects with nonparallel runners or leg patterns. Further, these designs only support legs, and therefore would break the runners of rocker-recliners supported by that design. The force on runners was discovered to be focused away from the corners, contrasting non-runner, chair legs.

Another design typical of its type uses a power driving lift, which is significantly more expensive to produce. Further, a safety issue arises when a power cord from an outlet to the lift mechanism is required. Unless the invention is sitting against a wall, the power cord would need to be laying across the floor, out to the middle of the room where the invention would be sitting. Someone using a walking device would get stuck or trip over the cord.

Another design typical of its type incorporates the lift integrally with the chair/recliner. User-supplied and existing chair/recliners therefore can not be accommodated.

Another design typical of its type requires users to screw the platform to the base of the recliner. Such designs can not be used for those recliners that have steel based frames. Typical of many designs, this design uses 4 pads on its base, and therefore cannot be adjusted for uneven floors or variations in floor coverings. Designs typically use rubber or other cushioning pads on feet located at the ends of a base. These limit the range of uneven floors that this invention can adapt to. The resulting instability causes a safety hazard for the infirm.

Another design typical of it type uses angle-iron supports which cause wood runners to warp and prevents wood runners to set flat on the base. Also, the design does not accommodate non-parallel runners.

### SUMMARY

Embodiments of the invention solve a problem of providing the least expensive and safely used cradle or lift fixture that can raise the height of a user-supplied load having almost any of the commonly encountered undercarriages. In particular, a chair or recliner is lifted by a height that greatly reduces the physical difficulty of getting into and out the recliner. Many infirm individuals experience difficulty getting into and out of their chair or recliner.

In one specific embodiment of the invention, the problem of accommodating a chair whose undercarriage has non-parallel runners, or whose legs project a non-parallel pattern on the floor, or whose undercarriage has become deformed from its original condition, is solved by a lift incorporating continuously adjustable platform supports on which the chair rests, permitting and achieving a snug fit to the lift.

An exact, snug fit is enabled by a continuously adjustable platform support with continuously adjustable dimensions, thereby permitting a snug fit between nearly any chair undercarriage and the lift. Such adjustable dimensions permit the adjustable platform to accommodate load feet or runner patterns that form a four sided polygon with unequal side lengths and unequal interior angles and where the four corners do not all sit in the same plane. Such loads may project a non-coplanar, non-equal sided, non-parallel contact with the one or more telescoping supports.

In another specific embodiment of the invention the problem of assuring safety of operation, where the chair does not tip or fall over when a partly immobile person awkwardly sits into the chair is solved by a snug fit to the supports, widely spaced leveling glides of the lift, and leveling glide height adjustments. A leveling glide on a floor or surface supports a portion of a continuously adjustable platform.

Specific embodiments of the invention assure safety by employing four steps: 1. securing the feet or runners of the chair with a snug fit to the supports; 2. extending the leveling glides of the lift at least beyond the projection of the chair on the supporting floor; 3. providing height adjustments for at least one of the multiple feet of the lift, so as to accommodate an uneven surface on which the lift rests, and (4) not permitting the fixture to roll, by not using rollers, castors or wheels.

In another specific embodiment of the invention, the problem of making the least expensive lift that does not stress the runners of a chair to the point of breaking is solved by using additional leveling glides to support at least one continuously adjustable platform, using structurally competent materials, to make the continuously adjustable platform, and avoiding the use of electrical lifting mechanisms.

In another specific embodiment of the invention, at least one additional leveling glide is located near the vicinity of each point where the chair or load undercarriage runners are most stressed. A vicinity is defined as within several inches. This relieves the stress and may result in a lift with more than 4 leveling glides. Using structurally competent steel tubes as the construction material can minimize cost compared to other materials . Avoiding the use of electronic, electrical lifting mechanisms that depend on electrical cords or batteries entirely eliminates the mechanical hazards of electrical cords, such as tripping. The avoiding also minimizes the initial cost of the electrical motor and drive train and the continuing cost of maintenance of batteries and motors.

In another specific embodiment of the invention, the problem of preventing sagging of two or more supports fastened together and/or slippage between two supports is solved by welding or the use of other securing means at least one point of the seam between them near a position where sagging/slippage would be greatest. This point typically occurs at a point between ¼ and ½ of the distance from the front of the load on the support. An upper support comprises telescoping elements, providing continuously adjustable length. A lower support attached to it provides both a base to attach extra supporting leveling glides and a mechanism to lock the upper one.

In another specific embodiment of the invention, the problem of conveniently elevating a load off an even or uneven platform with supports of said load that are equally or unequally spaced is solved by a means of load bearing sides, referred to as elongated supports or continuously adjustable platform supports, independently adjustable in length, and with independently adjustable panels supported with a plurality of independently adjustable leveling glides.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present teachings.

All of the following drawings may not be to scale and some may not be proportional only to better illustrate details. All drawings are top view isometrics or side views for further clarification. Subassembly drawings of the embodiment are provided for additional information. To minimize crowding of some of the larger detailed drawings, small attaching hardware, i.e., hex bolt—long (53), hex bolt—short (57), squared crowned nut (51), flat washer (54), lock washer (55), and nut (56) are shown in detail only on the subassembly drawings.

FIG. 1 shows the embodiment and a user's chair/recliner (50). The chair/recliner (50) is not part of this application.

FIG. 1A shows an expanded view of the embodiment

FIG. 1B shows the embodiment configured for a recliner with non-parallel runners

FIG. 2 shows a long side top rail (41)

FIG. 3 shows a long side bottom rail (42)

FIG. 4 shows an assembly of a section of the long side of the embodiment

FIG. 5 shows a long side short top rail (44)

FIG. 6 shows a long side short bottom rail (45)

FIG. 7 shows an adjustment rail (43)

FIG. 8 shows an assembly of one end of the long side of the embodiment.

FIG. 9 shows the assembly of the leveling glide (40) with bottom of the long side bottom short rail (45) welded to the long side short top rail (44)

FIG. 10 shows the assembly of the leveling glides (40) with the long side bottom rail (42) welded to the long side bottom top rail (41)

FIG. 11 shows an assembly of the right side of the embodiment

FIG. 11A shows the side view of the right side of the embodiment

FIG. 12 shows the short side left panel (46)

FIG. 13 shows the short side right panel (47)

FIG. 14 shows the assembly of a short side of the embodiment

FIG. 15 shows the assembly of a left corner of the embodiment

FIG. 16 shows the assembly of a right corner of the embodiment

FIG. 16A show the ability of the long side rails to swivel with a short side end assembly

FIG. 17 shows the end cap (49)

FIG. 18 shows the corner guide (48)

FIG. 19 shows the leveling glide (40)

FIG. 20 shows the square crowned nut (51)

FIG. 21 shows the set screw (52)

FIG. 22 shows the hex bolt—long (53)

FIG. 23 shows the hex bolt—short (57)

FIG. 24 shows the nut (56)

FIG. 25 shows the lock washer (55)

FIG. 26 shows the flat washer (54)

### DETAILED DESCRIPTION

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Tests were conducted and it was discovered that when a chair or recliner was lifted only a few inches, it became significantly easier for these individuals to get out of the chair or recliner.

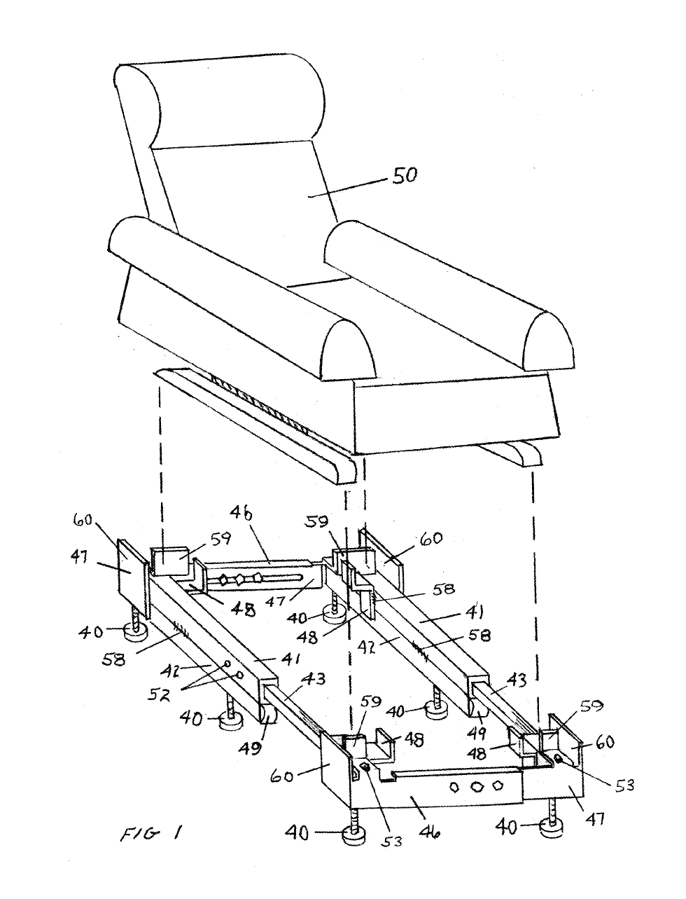

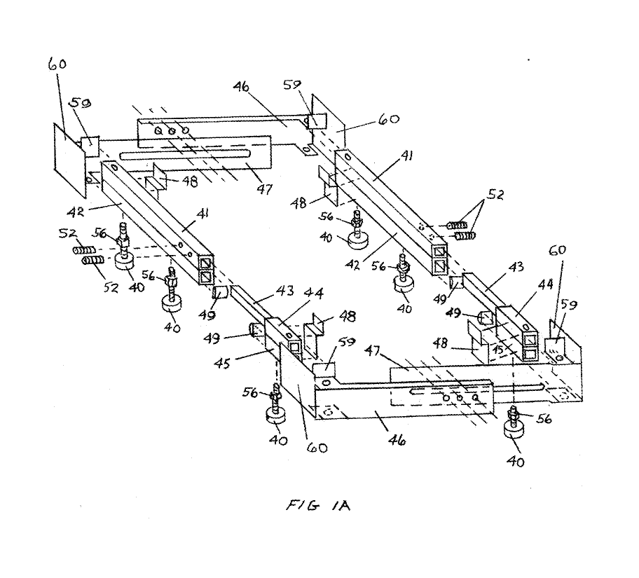

In the detailed description which follows, all parts are identified with reference numbers throughout this specification and on all drawings. The drawings are not to scale. Some drawings are not in proportion or have been exaggerated to better show details of the embodiment. Additional subassembly drawings are included to show details and to provide clarification of top assembly drawings. The term chair/recliner refers to commercially available chairs, recliners and rocker-recliners and are not part of this embodiment. The term “load” refers to chair/recliners and other bulky or heavy apparatus, such as those often found in shops and work areas. Manufacturers of many of the recliners available today offer at a minimum, three different undercarriages for supporting the recliners. One type of recliner uses parallel wood runners with various lengths and widths as shown in FIG. 1 on chair/recliner (50). Another type of recliner uses non-parallel runners with various lengths and widths converging in the front of the chair/recliner (50). Another type of chair/recliner (50) uses four steel legs with spacing of various lengths and widths. The undercarriages may become deformed, bent or significantly deviate from their original form. An embodiment of the invention is designed to support each of these variations of undercarriage designs of chairs and recliners as well as those undercarriages that have become deformed.

The design of the embodiments provide a safe and sturdy lift for chairs and recliners manufactured with a variety of different undercarriages. The embodiment can be adjusted for different widths and different lengths of chairs/recliners (50) undercarriages and can also provide different heights for the user's comfort and for easy egress.

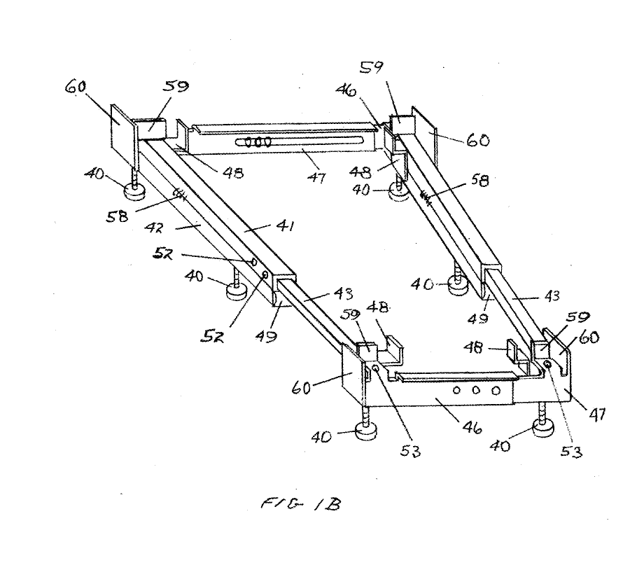

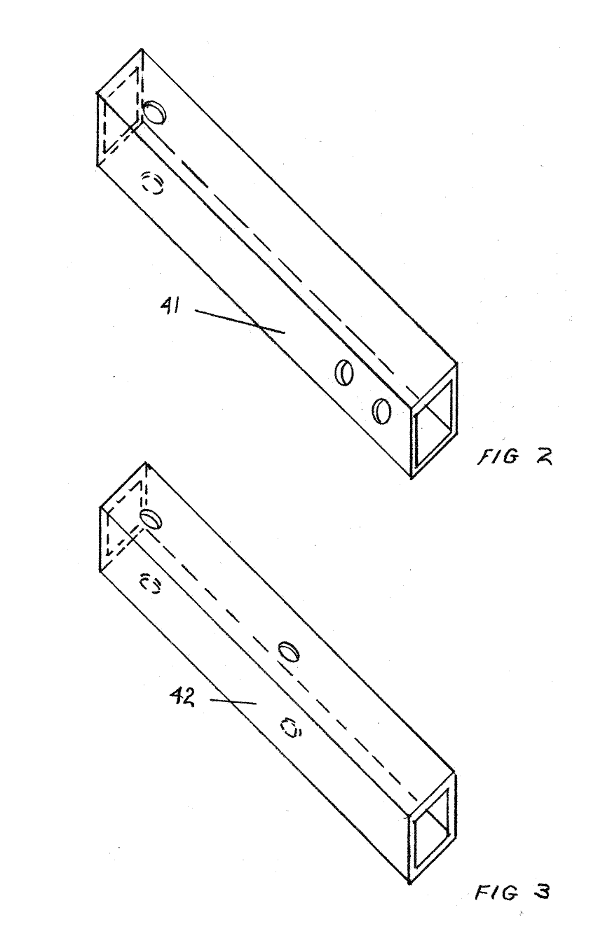

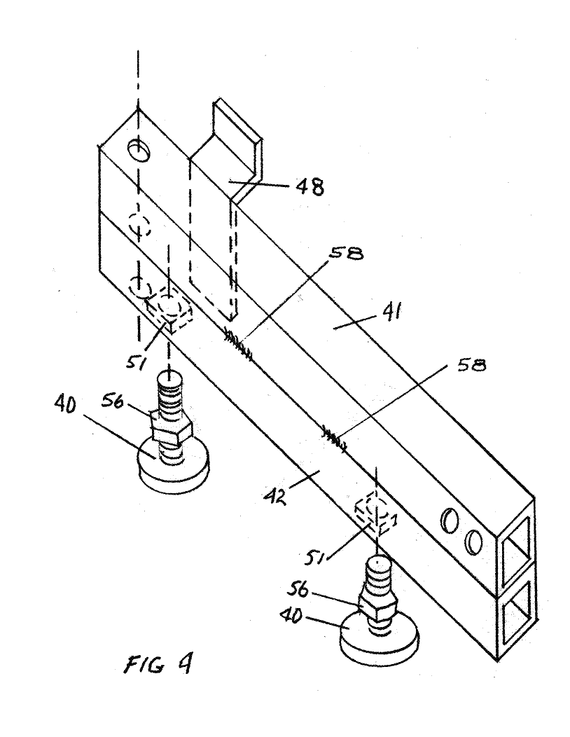

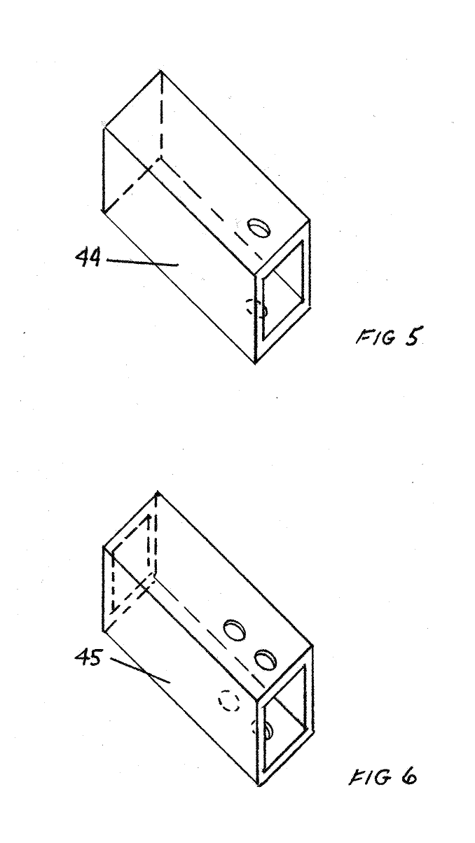

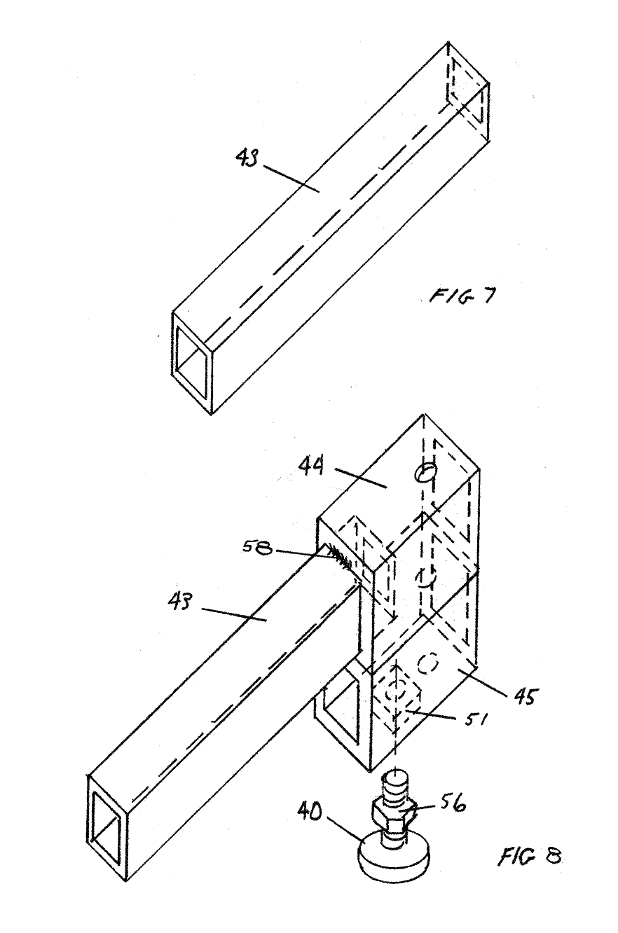

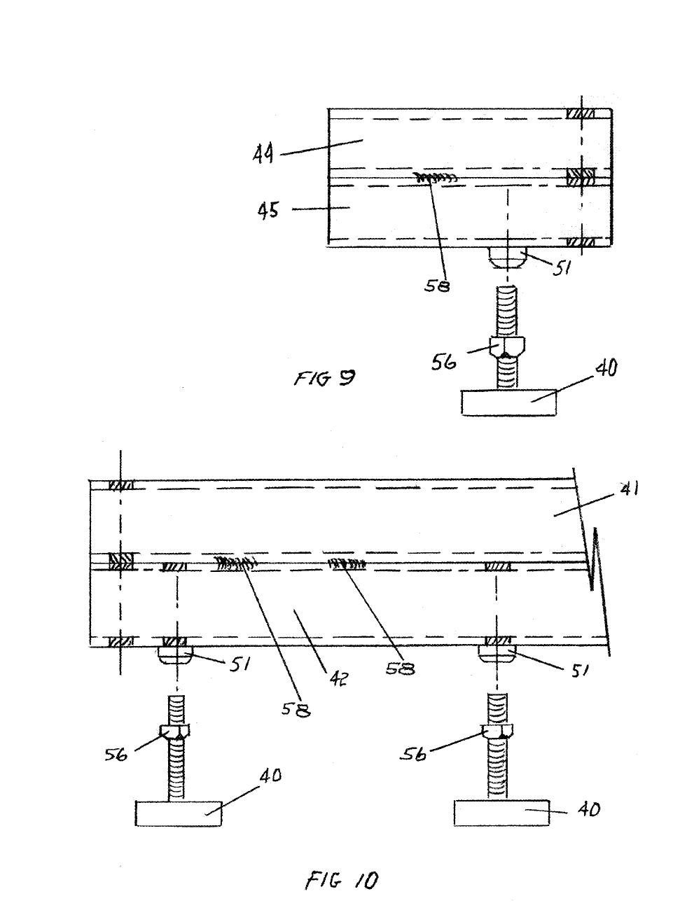

FIG. 1 shows the relationship between the chair/recliner (50) and the embodiment. FIG. 1A is an expanded view of the embodiment with two long sides and two short sides. FIGS. 2, 3, 5 and 6 show each of the parts of the total long sides of the embodiment. Each long side of the embodiment has a long side top rail (41) that is welded (58), as shown in FIGS. 4 and 10, to a long side bottom rail (42). Each long side short top rail (44) of the embodiment is welded (58), as shown FIGS. 8 and 9, to a long side short bottom rail (45).

FIG. 7 shows the adjustment rail (43) and FIG. 8 shows one end of an adjustment rail (43) is welded (58) to a long side short top rail (44). The long side top rails (41), long side bottom rails (42), long side short top rails (44) and long side short bottom rails (45) are made of a heavy gauge square steel tubing. The tubing can have any cross section as long as the tube is structurally competent. A surface must be available or provided to accommodate load feet or runners. When the undercarriage uses neither feet nor runners, a separate platform can be provided. The platform matches the load undercarriage. Another side of the platform matches the supporting surfaces of the telescoping supports.

FIG. 10 shows the welds (58) along the sides of the long side tops rail (41) to the long side bottom rail (42) provides the embodiment with significant added strength and also minimizes sagging and prevents slipping in the long sides of the embodiment. FIG. 9 shows the welds (58) along the sides of the long side short top rail (44) to the long side bottom rail (45) provides the embodiment with significant added strength and prevents slipping in the long sides of the embodiment.

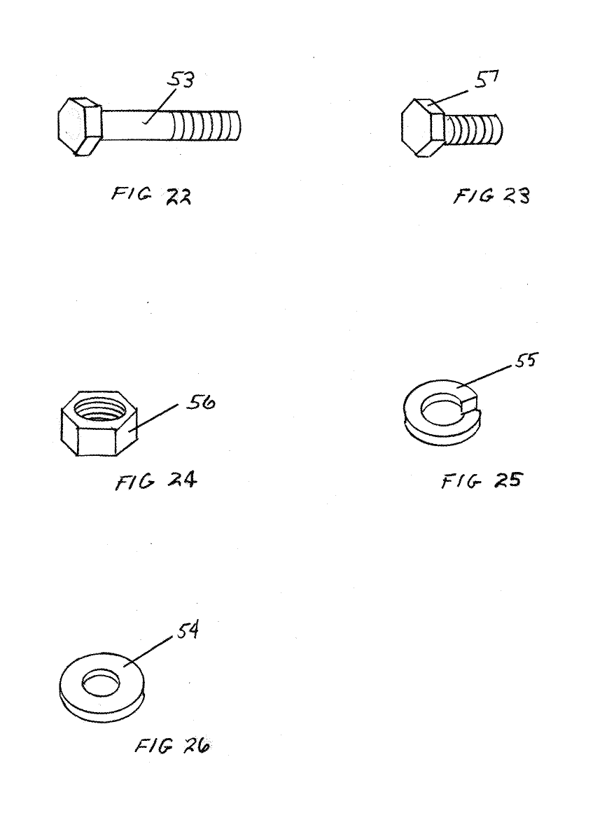

FIG. 11, 11A is the assembly of the right hand long side of the embodiment. In order to accommodate the various lengths of undercarriages of chairs/recliners (50), each of the long sides of the embodiment is designed to be adjustable in length. One end of the adjustment rail (43) is welded (58) to the long side short top rail (44) and the other end of the adjustment rail slides into the end of the long side top rail (41). This design provides a continuously variable adjustment of the long sides of the embodiment. Once the long sides of the embodiment have been set in place that matches the length of the runners or legs of the undercarriage of the chair/recliner (50), two redundant set screws (52) on each of the outsides of the long side top rails (41) are tightened to secure the adjustment rail (43). Two square crowned nuts (51) shown in FIGS. 11 and 20, are welded (58) to the outside of each of the long sides of the embodiment at the long side top rails (41) providing threading for the set screws (52) as shown in FIG. 11.

FIG. 1 shows how the chair/recliner (50) sets on the two long side top rails (41) and the two long side short top rails (44). An important part of the design of the embodiment is to provide a safeguard that prevents a chair/recliner 50) from slipping horizontally. In each of the FIGS. 1, 1A, 1B, 4, 11, 11A, and 18, the corner guides (48) with welds (58) to the insides of each long side top rails (41) and each of the long side short top rails (44) provide stops to prevent the chair/recliner (50) from sliding off the embodiment in the horizontal direction.

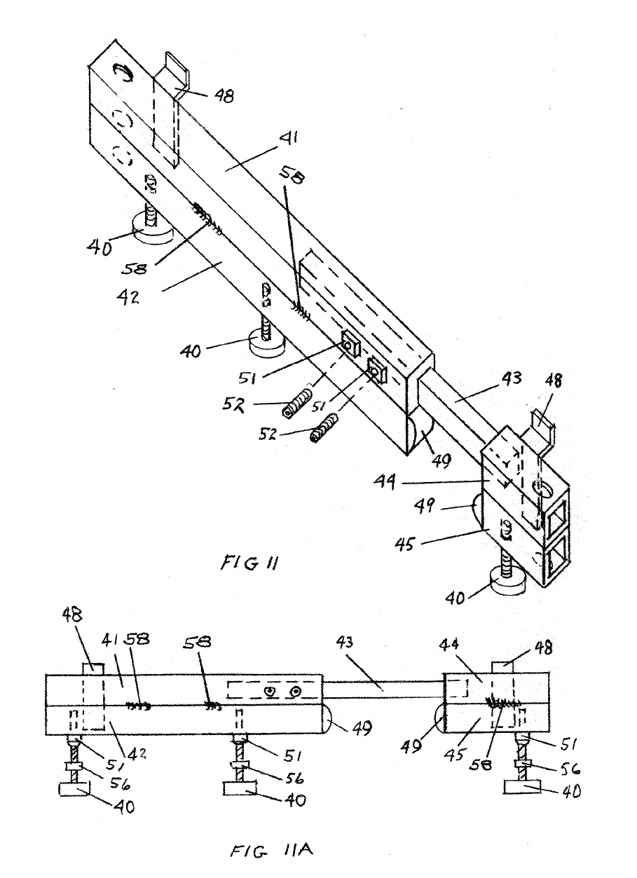

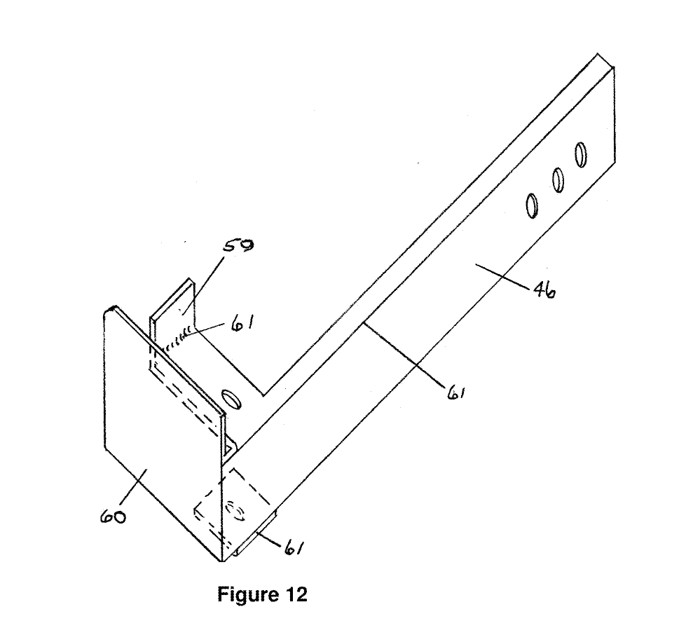

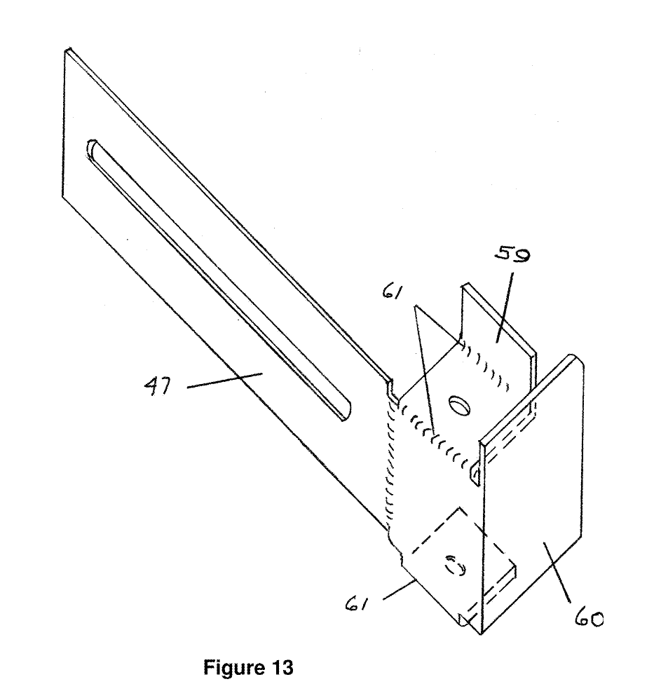

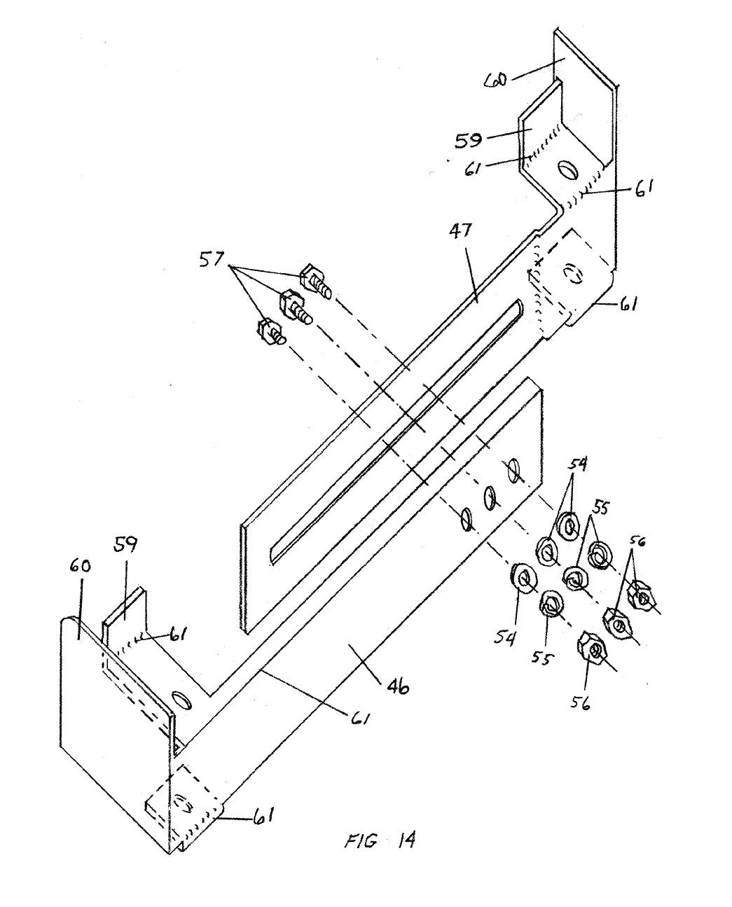

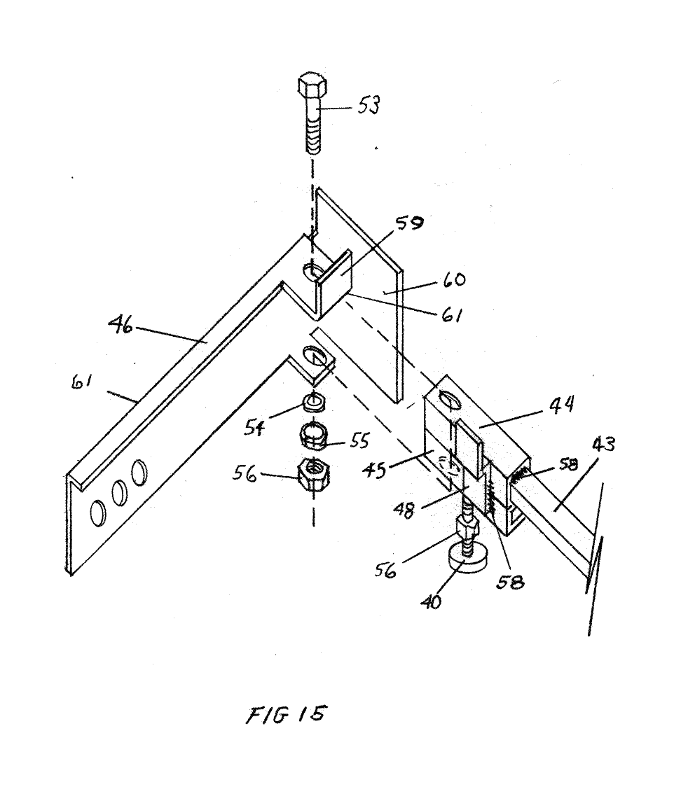

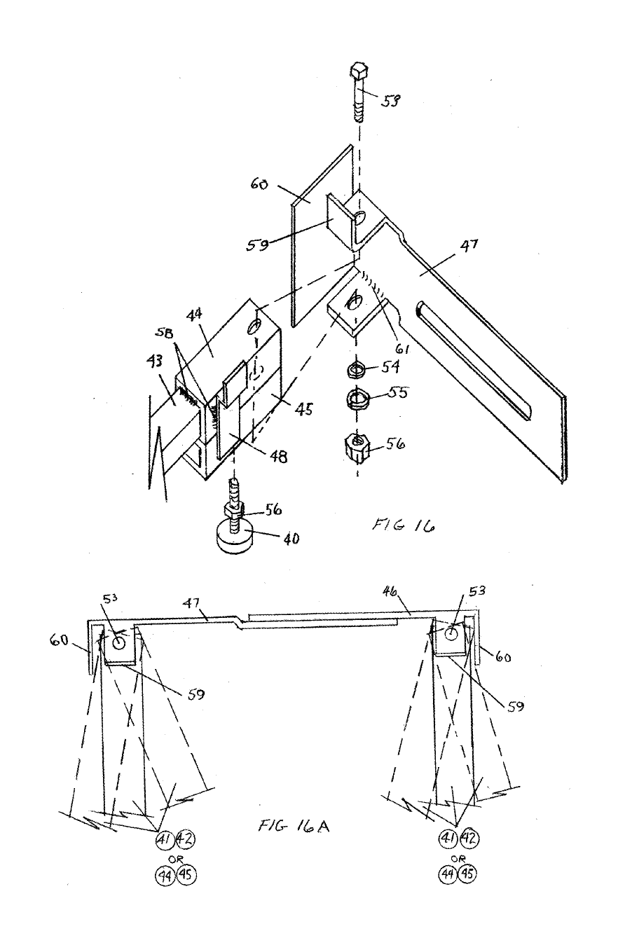

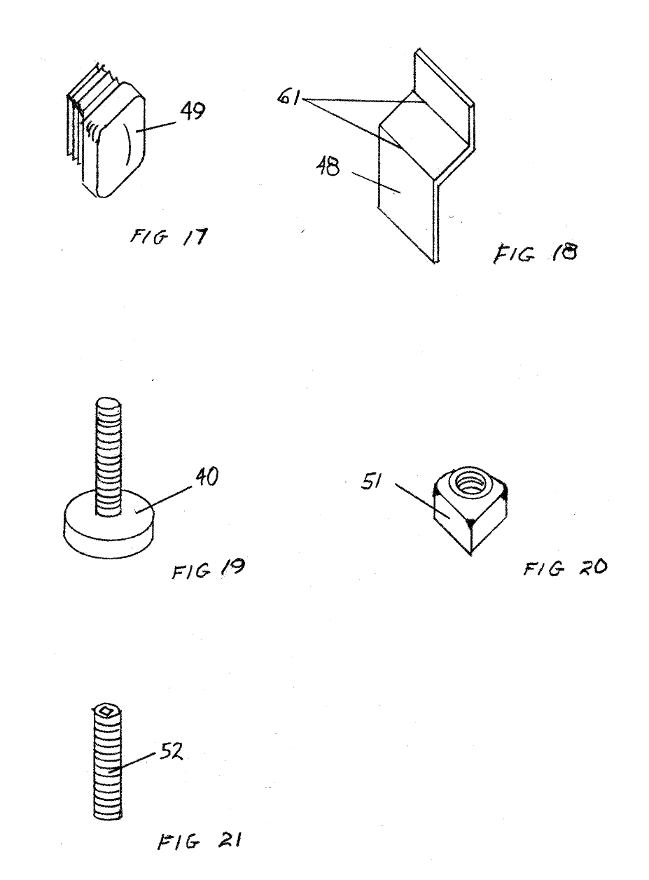

The widths of the undercarriages of chairs/recliners (50) vary significantly with different manufacturers. It is equally important that the design of this embodiment can accommodate the various widths of the undercarriages of the commercially available chairs/recliners (50). FIGS. 12 and 13 are the short side left panel (46) and the short side right panel (47) respectively. The assembling of these two short side supports together (FIG. 14), provides several different functions. This assembly provides a method of adjusting the widths of the embodiment. This assembly provides stop (59) for the runners and legs of a char/recliner (50) preventing the chair/recliner (50) from sliding forward and aft. This assembly provides guides (60) for the runners and legs of a chair/recliner (50) preventing the chair/recliner (50) from sliding in the inward and outward directions from either side of the embodiment.

FIG. 14 shows the assembly for adjusting the widths of the embodiment. The front and rear of the embodiment has an assembly as shown in FIG. 14. Three hex bolt—short (57) shown in FIGS. 14 and 23 are inserted through the groove of the short side right panel (47) and through the three holes in the short side left panel (46). A flat washer (54) FIGS. 14 and 26, a lock washer (55) FIGS. 14 and 25 are placed over each of the hex bolt—short (57) and a nut (56) FIGS. 14 and 24 are screwed onto each of the three hex bolt—short (57) and is ready for tightening. The location of the three nuts (56) may face outward of the embodiment for easy access and for tightening. Each end of the embodiment has a short side left panel (46) and each short side left panel (46) has a 90-degree bend (61) along the top edge to align with its respective short side right (47).

Both the short side left panel (46) and the short side right panel (47) has a 90-degree bend (61) as shown in FIGS. 12, 13, 14, 15 and 16). When the short side left panel (46) and the short side right panel (47) are connected to the long side short top rails (44) using hex bolt—long (53) and the chair/recliner (50) undercarriage is set on the embodiment, the 90 degree bends (61) in the short side left panel (46) and the short side right panel (47) prevent the undercarriage of the chair/recliner (50) from moving forward or aft on the embodiment.

Both the short side left panel (46) and the short side right panel (47) have a 90-degree bend (61) providing guides (60) as shown in FIGS. 1, 1A, 1B, 12, 13, 14, 15, and 16. When the short side left panel (46) and the short side right panel (47) are connected to the long side short top rails (44) using hex bolt—long (53) and the chair/recliner (50) is set on the embodiment, the guide (60) of the short side left panel (46) and the short side right panel (47) prevents the chair/recliner (50) from sliding in the outward direction off either side of the embodiment.

An embodiment An embodiment may include telescoping supports that are canted more than 30 degrees from the horizontal plane, to accommodate unusual undercarriages.

The embodiment is designed to hold chairs/recliners (50) that have an undercarriage with non-parallel runners. FIG. 1B shows the embodiment adjusted to support this non-parallel runners requirement. Here, one end of the embodiment is wider than the other end. The lengths of all four sides of the embodiment can be adjusted independently. Each adjustment is continuously variable and may be accessible from the outside of the embodiment for ease of tightening. For safety, it is important for the embodiment to provide continuous adjustments in both length of the embodiment and in its width and to assure a snug fit and that the adjustments once set, have redundant tightening devices to prevent a single point of failure.

FIG. 16A is a top view of an assembly at the short end of the embodiment (short side left panel (46) and a short side right panel (47) connected to the long side rails by the hex bolt-long (53). With these connections at both ends of the side, the long side rails (41), (42) or (44), (45) are able to swivel to make an angle greater than or less than 90-degrees as a means to accommodate those chairs/recliners (50) designed with undercarriages with non-parallel runners. The range of the swivel can be up to 30 degrees in either direction from 90 degrees.

The embodiment's height is adjusted with the use of the leveling glides (40) shown in FIGS. 1, 1A, 1B, 8, 9, 10, 11A, and 15. There is a plurality of leveling glides (40). The leveling glides (40) not only provide elevation of the embodiment but can also be adjusted independently to compensate for uneven floors and variations in floor coverings.

It was discovered that the manufacturers of chairs/recliners (50) with runners (parallel or non-parallel), position the majority of the load approximately one-third the distance from the front of the runners. For this reason, the design of the embodiment places an additional leveling glide (40), on both sides of the embodiment, approximately one-third the distance from the front of the embodiment. The range of the position is from about ⅛ to about ⅞ of the distance to the front support.

Leveling glides (40) screw into square crowned nuts (51) welded (58) to the bottoms of both the long side bottom rails (42) and both long side short bottom rails (45). To prevent the leveling glides (40) from loosening during normal use of the embodiment, nuts (56) are added to the shafts of each leveling glide (40) and acts as a locking device when tightened.

FIGS. 11 and 11A shows end caps (49) inserted into one end of each long side bottom rails (42) below the adjustment rails (43). End caps (49) are also inserted into one end of each long side short bottom rail (45). The end caps (49) prevent insects, dust, rodents or other small animals from entering these rails. End caps (49) also provide a cosmetic finish to the ends of the squared steel tubing used in the fabrication of each long side bottom rails (42) and long side short bottom rails (45).

A finish is applied to the embodiment to protect against rust and corrosion as well as for cosmetic purposes.

An embodiment configures the connections of support elements such as telescoping tubes to be able to swivel out of the horizontal plane by up to 30 degrees. This permits a load such as a chair to be tipped for either comfort or ease of access.

The operation of this embodiment takes place only in the initial setup to ensure that there is a snug fit between the chair/recliner (50) and the embodiment. After the embodiment has been assembled as shown in and FIG. 1B and FIG. 11 with both set screws (52) loose on both long side top rails, the distance between the stop (59) at one end of the long side of the embodiment and the stop (59) at the opposite end of the long side is set to the identical length as that of the runner on the chair/recliner (50) by sliding the adjust rail (43) in or out. Once the exact length is attained, the set screws (52) are tightened to assure that the set length of that side of the embodiment does not change. This same operation is repeated for the opposite long side of the embodiment.

After the length of the embodiment has been set, the width of each end of the embodiment is ready to be set. The runners on the chair/recliner (50) may be parallel or they may not be parallel therefore the distance between runners in the front of the chair/recliner (50) may be different from the distance between runners in the back of the chair/recliner (50). The distance between the runners in the front of the chair/recliner (50) is measured. With the three hex bolts—short (57), the three flat washers (54), the three lock washers (55) and the three nuts (56) in place as shown in FIG. 14, the short side left panel (46) and the short side right panel (47) slide in or out until the distance between the guide (60) on the short side left adjustment support (46) and the guide (60) on the short side right panel (47) is the same distance between the measured runners on the chair/recliner (50). The nuts (56) may be facing the outside of the embodiment (for convenience), tighten the three nuts (56) to assure that the set width of that end of the embodiment does not change.

There is a plurality of leveling glides (40) as shown in FIGS. 1, 1A and 1B. The leveling glides (40) are used for two purposes, (1) elevating the embodiment to a height that is comfortable for the user and (2) adjusting the embodiment to set on uneven flooring and uneven floor coverings. Each leveling glide has a nut (56) for locking the height of the leveling glide (40) in place. The height of each leveling glides (40) can also be adjusted to account for variations in uneven floors and/or uneven floor coverings.

And Embodiment that supports loads by something other than flat runners or feet one needs only to include an additional fixture to mate the load to the fixture.

It would be advantageous to have the screws and adjustments be controlled by a computer, activated by a highly accessible control, such as a large button, and adjusted by a motor mechanism. Such mechanism would be exceptionally advantageous if the cost to include this were not significant compared to a lift without motors and/or computers.

It would be advantageous to provide hand-energized, hydraulic actuators to move the various elements of a lift. It would be advantageous to incorporate individual hydraulic actuators with individual controls and built in stops when the leveling and lifting is done. It would be exceptionally advantageous if these can be done at an affordable cost. An embodiment minimizing cost has no electrical or hydraulic mechanisms to adjust or fasten the glides or supports

Embodiments of this invention are not limited to providing an elevating mechanism for chairs, recliners or rocker-recliners. An embodiment can be used to elevate many other items. As a non-limiting example, a washing machine, dryer, bed or a table can easily be elevated using this embodiment. The embodiment is not limited only to home applications. The embodiment can withstand loads greater than 800 pounds. A platform can be placed on the embodiment so that it can be used in the commercial environment where equipment and/or work tables can be elevated to assist employees from excessive bending in their day-to-day work functions and thus preventing bodily injuries.

An rolling embodiment of the invention includes castors or wheels in addition to or instead of leveling glides (40. The rolling embodiment becomes a mobile elevated platform capable of moving heaving loads when needed. The embodiment can be made of other materials exhibiting strengths necessary to support the particular application. The safest platform does not permit rolling contact with the floor. However a fixture with casters or wheels is inherently more useful in a shop.

Although the invention has been described with reference to particular embodiments, the description is only an example of the invention's application and should not be taken as a limitation. Various other adaptations and combinations of features of the embodiments disclosed are within the scope of the invention as defined by the following claims.

1. A fixture resulting in a safe, stable lifted support on which to tightly fasten almost all chairs or recliners used by aged, frail or otherwise physically challenged users comprising:
a cradle configured to support a chair/recliner load that is supported by its runners or feet, the cradle having one or more telescoping supports that can swivel in a horizontal plane up to 30 degrees in either direction;
the one or more telescoping supports configured so that the telescoping length can be continuously adjusted to tightly secure and form a snug fit to the feet or runners of the chair/recliner load;
a safeguard built into each telescoping support configured to prevent a chair/recliner from slipping horizontally, the safeguard comprising at least one guide or stop at each end to prevent the chair/recliner from sliding in the inward and outward directions or from left to right from any side of the fixture;
the dimensions of all the supports and of the leveling glides configured to be adjustable from the outside of the fixture while the load is in place;
the supports further including at least two, redundant tightening devices, such as set screws, that lock down the length of the telescoping support, the devices accessible from the outside of the lift,
an undercarriage supporting the cradle also having at least one adjustable leveling glide or foot to accommodate a non-level, non-planar floor;
the outermost leveling glides also placed beyond the projection of any part of the chair/recliner load on the horizontal plane;
the plurality of leveling glides being adjustable independently, to accommodate uneven floors;
each leveling glide having a locking feature, such as a locking nut, to independently lock each in place;
long top and long bottom support rails formed with one on top of the other and fastened together by welding or the use of other securing means, the securing means located between ¼ and ½ of the distance from the front of the load on the support to prevent slipping between the top and bottom rails,
Each end of the fixture having a short side left panel and a short side right panel having a safety stop, wherein each short side panel left, or right, has a 90-degree bend along the top edge to align with its respective short side right, or left, respectively:
an undercarriage supporting the cradle, both of the long sides of the undercarriage also having an additional leveling glide approximately one-third the distance from the front of the undercarriage along a location from about ⅛ to about ⅞ of the distance to the front support, the additional glide located to prevent breakage of a chair/recliner supported by runners.

2-16. (canceled)

17. A fixture as in claim 1 having an additional safety feature wherein no power cords protrude from any part of the lift.

18. A fixture as in claim 1 having an additional safety feature wherein the glides do not have a rolling or sliding contact or connection to the floor.

19. A fixture as in claim 1 having an additional degree of freedom wherein a telescoping support may accommodate being canted more than 30 degrees out of the horizontal plane.

20. A fixture as in claim 1 wherein each adjustment can be adjusted while the load is in place and while the fixture is in use.
